(19) United States
(12) Patent Application Publication
(10) Pub. No.: US 2016/0371353 A1
(43) Pub. Date: Dec. 22, 2016

(54) A METHOD AND SYSTEM FOR PROCESSING DATA

(71) Applicant: QATAR FOUNDATION, Doha (QA)

(72) Inventors: Marco SERAFINI, Doha (QA); Essam MANSOUR, Doha (QA); Ashraf ABOULNAGA, Doha (QA)

(21) Appl. No.: 14/910,970

(22) PCT Filed: Jun. 27, 2014
(86) PCT No.: PCT/GB2014/051973

§ 371 Date: Feb. 8, 2016

(30) Foreign Application Priority Data
Jun. 28, 2013 (GB) 1311686.8
Feb. 3, 2014 (GB) 1401808.9

(51) Int. Cl. G06F 17/30; H04L 29/08

(52) U.S. Cl. CPC G06F 17/30575; G06F 17/30584; H04L 67/1002

(57) ABSTRACT

A system of redistributing partitions across servers having multiple partitions that each process transactions. Where the transactions are related to one another and the transactions are able to access one or a set of partitions simultaneously. The system comprising: a monitoring module operable to determine a transaction rate of the number of transactions processed by the multiple partitions on the first server; an affinity module operable to determine affinity between partitions, wherein the affinity being a measure of how often group transactions access sets of respective partitions; a partition placement module operable to determine a partition mapping in response to a change in a transaction workload on at least one partition on the first server, the partition placement module operable to receive input from at least one of: a server capacity estimator module; wherein server capacity estimator module is operable to determine the maximum transaction rate and use a pre-determined server-capacity-function; the affinity module; and distributing the partitions according to the determined partition mapping from the first server to a second server.

### BACKGROUND

Distributed computing platforms, namely clusters and public or private clouds, enable applications to effectively use resources in an on demand fashion, for example by asking for more servers when the workload increases and releasing servers when the workload decreases. For example Amazon's EC2 has access to a large pool of physical or virtual servers.

Providing the ability to elastically use more or fewer servers on demand (scale out and scale in) as the workload varies is essential for database management systems (DBMSes) deployed on today's distributed computing platforms, such as the cloud. This requires solving the problem of dynamic (online) data placement. In DBMSes where Atomicity, Consistency, Isolation, Durability (ACID) transactions can access more than one partition, distributed transactions represent a major performance bottleneck. Multiple-tenants hosted using the same DBMS on a system can introduce further performance bottlenecks. Partition placement and tenant placement are different problems but pose similar issues to performance.

Online elastic scalability is a non-trivial task. Database management systems (DBMSes), whether with a single tenant or multi-tenanted, are at the core of many data intensive applications deployed on computing clouds, DBMSes have to be enhanced to provide elastic scalability. This way, applications built on top of DBMSes will directly benefit from the elasticity of the DBMS.

It is possible to use (shared nothing or data sharing) partition-based database systems as a basis for DBMS elasticity. These systems use mature and proven technology for enabling multiple servers to manage a database. The database is partitioned among the servers and each partition is “owned” by exactly one server. The DBMS coordinates query processing and transaction management among the servers to provide good performance and guarantee the ACID properties.

Distributed transactions appear in many workloads, including standard benchmarks such as TPC-C (in which 10% of New Order transactions and 15% of Payment transactions access more than one partition). Many database workloads include joins between tables, and some joins (including key-foreign key joins) can be joins between tables of different partitions hosted by different servers, which gives rise to distributed transactions.

Performance is sensitive to how the data is partitioned, conventionally the placement of partitions on servers is static and is computed offline by analysing workload traces. Scaling out and spreading data across a larger number of servers does not necessarily result in a linear increase in the overall system throughput, because transactions that used to access only one server may become distributed.

To make a partition-based DBMS elastic, the system needs to be changed to allow servers to be added and removed dynamically while the system is running, and to enable live migration of partitions between servers. With these changes, a DBMS can start with a small number of servers that manage the database partitions, and can add servers and migrate partitions to them to scale out if the load increases. Conversely, the DBMS can migrate partitions from servers and remove these servers from the system to scale in if the load decreases.

According to one aspect of the present invention there is provided a method of redistributing partitions between servers, wherein the servers host the partitions and one or more of the partitions are operable to process transactions, each transaction operable to access one or a set of the partitions, the method comprising determining an affinity measure between the partitions, the affinity being a measure of how often transactions have accessed the one or the set of respective partitions; determining a partition mapping in response to a change in a transaction workload on at least one partition, the partition mapping being determined using the affinity measure; and redistributing at least the one partition between servers according to the determined partition mapping.

Preferably determining a transaction rate for the number of transactions processed by the one or more partitions across the respective servers; and determining the partition mapping using the transaction rate;

Preferably dynamically determining a server capacity function; and determining the partition mapping using the determined server capacity function.

Preferable the transaction workload on each server is below a determined server capacity function value, and wherein the transaction workload is an aggregate of transaction rates.

The partition mapping may further comprise determining a predetermined number of servers needed to accommodate the transactions; and redistributing the at least one partition between the predetermined number of servers, wherein the predetermined number of servers is different to the number of the servers hosting the partitions. The predetermined number of servers is preferably a minimum number of servers.

The server capacity function may be determined using the affinity measure. The affinity measure is preferably at least one of: a null affinity class; a uniform affinity class; and an arbitrary affinity class.

Preferably the partition is replicated across at least one or more servers.

### DRAWINGS

So that the present invention may be more readily understood, embodiments of the present invention will now be described, by way of example, with reference to the accompanying drawings, in which:

FIG. 1 shows a schematic diagram of the overall partition re-mapping process;

FIG. 2: shows a preferred embodiment with a current set of partitioned database partitions and interaction between modules.

FIG. 3: Server capacity with uniform affinity (TPC-C);

FIG. 4: Server capacity with arbitrary affinity (TPC-C with varying multi partition transactions rate);

FIG. 5: Effect of migrating different fractions of the database in a control experiment.

FIG. 6: Example effect on throughput and average latency of reconfiguration using the control experiment.

FIG. 7: Data migrated per reconfiguration (logscale) and number of servers used with null affinity for embodiments of the present invention, Equal and Greedy methods.

FIG. 8: Data migrated per reconfiguration (logscale) and number of servers used with uniform affinity for embodiments of the present invention, Equal and Greedy methods.

FIG. 9: Data migrated per reconfiguration (logscale) and number of servers used with arbitrary affinity for embodiments of the present invention, Equal and Greedy methods.

Embodiments of the present invention seek to provide an improved computer implemented method and system to dynamically redistribute database partitions across servers, especially for distributed transactions. The re-distribution in one aspect may take into account where the system is a multi-tenant system based on the DBMS.

Embodiments of the invention dynamically redistribute database partitions across multiple servers for distributed transactions by scaling out or scaling in the number of servers required. There are significant energy, and hence cost, savings that can made by optimising the number of required servers for a workload at any particular time.

Embodiments of the present invention relate to a method and system that addresses the problem of dynamic data placement for partition-based DBMSes that support local or distributed ACID transactions.

We use the term transaction to describe a sequence of read-write accesses, where the term transaction includes a single read, write or related operation.

A transaction may be comprised of several individual transactions. The individual transactions, that combine to form the transaction. Transactions may access the same partition on the same server or distributed partitions on the same server or across a cluster of servers.

The term ‘transaction’ used in context of TPP-C and other workloads may be interpreted as a transaction for business or commercial purposes, which in the context of database systems may comprise one or more individual database transactions (get/put actions).

A preferred embodiment of the invention is in the form of a controller module that addresses the dynamic partition placement for partition-based elastic DBMSes which support distributed ACID transactions, i.e., transactions that access multiple servers.

Another preferred embodiment, for example, may use a system based on H-Store, a shared-nothing in-memory DBMS. The preferred embodiment in such an example achieves benefits compared to alternative heuristics of up to an order of magnitude reduction in the number of servers used and in the amount of data migrated, we illustrate the advantages of the preferred embodiment later in the description.

A further preferred embodiment preferably comprises using dynamic settings where at least one of: the workload is not known in advance; the load intensity fluctuates over time; and access skew among different partitions can arise at any time in an unpredictable manner.

Another preferred embodiment may be invoked manually by an administrator, or automatically at periodic intervals or when the workload on the system changes.

A further preferred embodiment handles at least one of: single-partition transaction workloads; multi-partition transaction workloads; and ACID distributed transaction workloads. Other non-OLTP (OnLine Transaction Processing) based workloads may be used with embodiments of the invention.

The preferred embodiment uses modules to determine a re-mapping and preferably a re-distribution of partitions across multiple servers.

A monitoring module periodically collects the rate of transactions processed by each of its partitions, which represents system load and preferably: the overall request latency of a server, which is used to detect overload; the memory utilization of each partitions a server hosts.

An affinity module determines an affinity value between partitions, which preferably indicates the frequency in which partitions are accessed together by the same transaction. The affinity module may determine the affinity matrix and an affinity class using information from the monitoring module. Optionally the affinity module may exchange affinity matrix information with the server capacity estimator module.

A server capacity estimator module considers the impact of distributed transactions and affinity on the throughput of the server, including the maximum throughput of the server It then integrates this estimation using a partition placement module to explore the space of possible configurations in order to decide whether to scale out or scale in.

A partition placement module uses information on server capacity to determine the space of possible configurations for re-partitioning the partitions across the multiple servers, and any scale-out or scale-in of servers needed. The space of possible configurations may include all possible configurations.

Preferably the partition placement module uses the information on server capacity where the the capacity of the servers is dynamic, or changing with respect to time, to determine if a placement is feasible, in the sense that it does not overload any server.

A partition placement module of the preferred embodiment preferably at least computes partition placements that:
a) keep the workload on each server below its capacity (which we term a feasible placement) and/or a determined server capacity, the server capacity in one aspect may be pre-determined;
b) minimize the amount of data moved between servers to transition from the current partition placement to the partition placement proposed by the partition placement module and/or moving a pre-determined amount of data; and
c) minimize the number of servers used (thus scaling out or in as needed). We minimize the number of servers used to accommodate the workload, which includes both single-server transactions and distributed transactions.

A redistribution module operable to redistribute partitions between servers. The number of servers the partitions are redistributed to may preferably increase or decrease in number. Optionally the number of servers is the minimum required to accommodate the transactions. The redistribution module may exchange information regarding partition mapping with the partition placement module.

Distributed transactions have a major negative impact on the throughput capacity of the servers running a DBMS. The throughput capacity of a server can be determined using several methods. Coordinating execution between multiple partitions executing a transaction requires blocking the execution of transactions (e.g., in the case of distributed locking) or aborting transactions (e.g., in the case of optimistic concurrency control). The maximum throughput capacity of a server may be bound by the overhead of transaction coordination. If a server hosts too many partitions hardware bottlenecks may contribute to bounding the maximum throughput capacity of the server, for example hardware resources such as the CPU, I/O or networking capacity will contribute to bounding the maximum throughput capacity.

The affinity module preferably further comprises a method to determine a class of affinity. The preferred embodiment has three classes, however, the number of classes is not limited and sub-classes as well as new classes are possible as will be appreciated by the skilled person.
In one aspect the affinity module determines a null affinity class, where each transaction accesses a single partition. Null affinity is when the throughput capacity of a server is independent of partition placement and there is a fixed capacity for all servers.
In a second aspect the affinity module determines a uniform affinity class, where all pairs of partitions are equally likely to be accessed together by a multi-partition transaction. The throughput capacity of a server for uniform affinity is a function of only the number of partitions the server hosts in a given partition placement. Uniform affinity may arise in some specific workloads, such as TPC-C, and more generally in large databases where rows are partitioned in a workload-independent manner, for example according to a hash function.
In a third aspect the affinity module determines an arbitrary affinity class, where certain groups of partitions are more likely to be accessed together. For arbitrary affinity the server capacity estimator module must consider the number of partitions a server hosts as well as the exact rate of distributed transactions a server executes given a partition placement, which is computed considering the affinity between the partitions hosted by the servers and the remaining partitions.

Server Capacity Estimator Module and Partition Mapping

The server capacity estimator module characterizes the throughput capacity of a server based on the affinity between partitions using the output from the affinity module. The various aspects, ie classes, of the affinity module may be determined concurrently.

The server capacity estimator module preferably runs online without prior knowledge of the workload, and the server capacity estimator module adapts to a changing workload mix, i.e. is dynamic in its response to changes.

The partition placement module computes a new partition placement given the current load of the system and the server capacity estimations determined using the throughput, from the server capacity estimator module. The server capacity estimation may be in the form of a server capacity function.

Determining partition placements for single-partition transactions and distributed transactions can impose additional loads on the servers.

Where transactions access only one partition, we assume that migrating a partition p from a server s₁ to a server s₂ will impose on s₂ exactly the same load as p imposes on s₁, so scaling out and adding new servers can result in a linear increase in the overall throughput capacity of the system.

For distributed transactions: after migration, some multi-partition transactions involving p that were local to s₁ might become distributed, imposing additional overhead on both s₁ and s₂.

We must be cautious before scaling out because distributed transactions can make the addition of new servers in a scale out less beneficial, and in some extreme case even detrimental. The partition placement module preferably considers all solutions that use a given number of servers before choosing to scale out by adding more servers or scale in by reducing servers. The partition placement module preferably uses dynamic settings, from other modules, as input to determine the new partition placement. The space for ‘all solutions’ is preferably further interpreted as viable solutions that exist for n−1 servers when scaling in, where n is number of current servers in the configuration.

The partition placement module may use mixed integer linear programming (MILP) methods, preferably the partition placement module uses a MILP solver to consider all possible configurations with a given number of servers.

The partition placement module preferably considers the throughput capacity of a server which may depend on the placement of partitions and on their affinity value for distributed transactions.

The partitions are then re-mapped by either scaling in or scaling out the number of servers as determined by the partition placement module.

A preferred embodiment of the present invention is implemented using H-Store, a scalable shared-nothing in-memory DBMS as an example and discussed later in the specification. The results using TPC-C and YCSB benchmarks show that the preferred embodiment using the present invention outperforms baseline solutions in terms of data movement and number of servers used. The benefit of using the preferred embodiments of the present invention grows as the number of partitions in the system grows, and also if there is affinity between partitions. The preferred embodiment of the present invention saves more than 10× the number of servers used and in the volume of data migrated compared to other methods.

### DETAILED DESCRIPTION

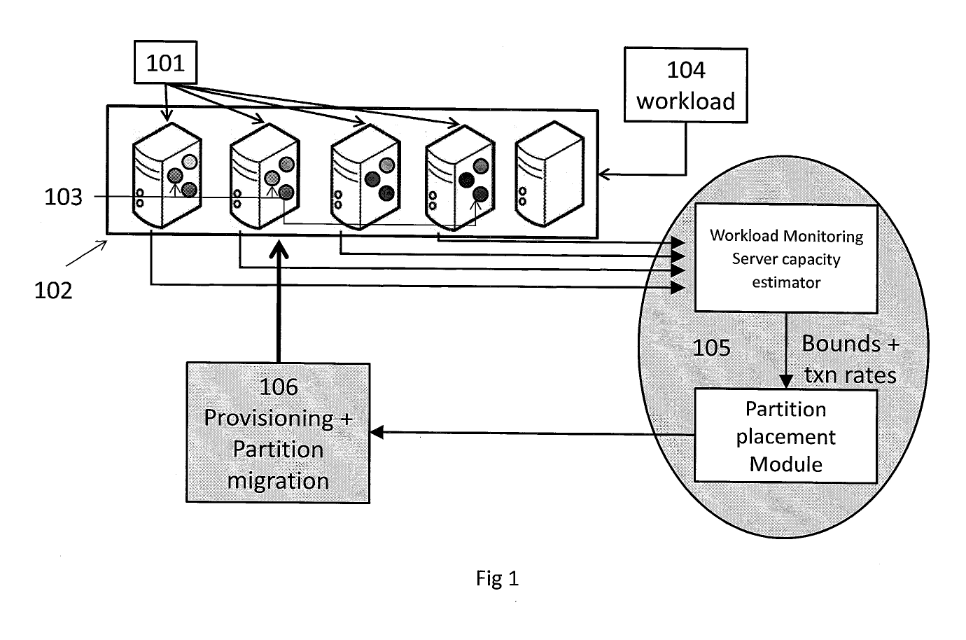

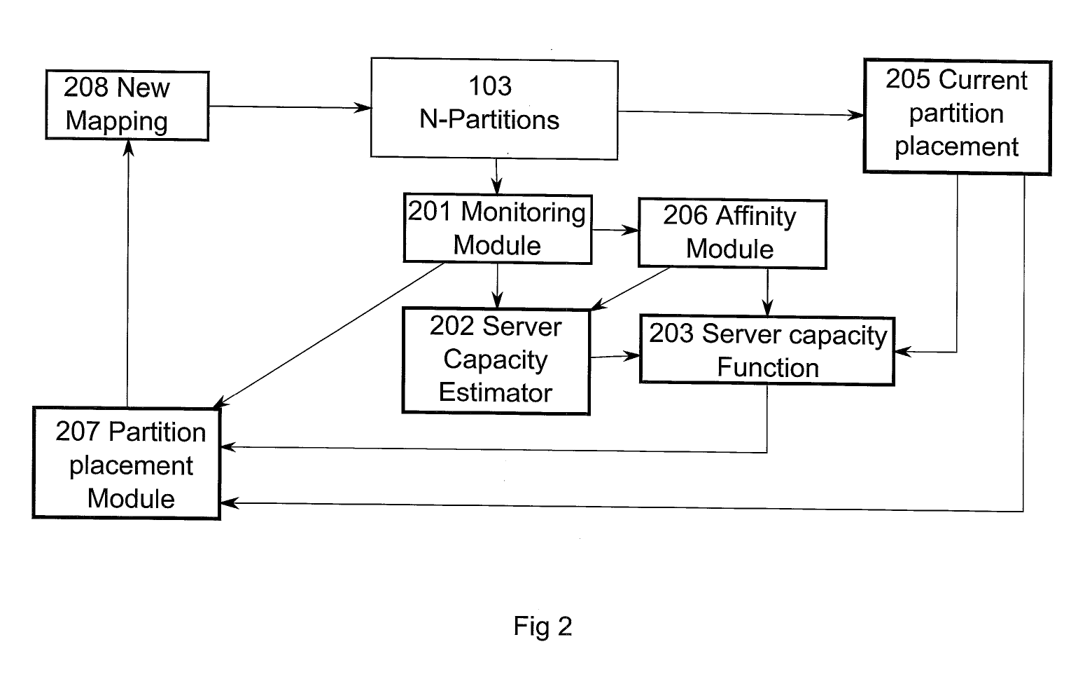

A preferred embodiment (FIG. 1) of the present invention partitions a database. Preferably, the database is partitioned horizontally, i.e., where each partition is a subset of the rows of one or more database tables. It is feasible to partition the database vertically, or using another partition scheme know in the state of the art. Partitioning includes partitions from different tenants where necessary.

A database (or multiple tenants) (101) is partitioned across a cluster of servers (102). The partitioning of the database is done by a DBA (Database Administrator) or by some external partitioning mechanism. The preferred embodiment migrates (103) these partitions among servers (102) in order to elastically adapt to a dynamic workload (104). The number of servers may increase or decrease in number according to the dynamic workload, where the workload is periodically monitored (105) to determine any change (106).

The monitoring module (201) periodically collects information from the partitions (103), preferably it monitors at least one of: the rate of transactions processed by each of its partitions (workload), which represents system load and the skew in the workload; the overall request latency of a server, which is used to detect overload, the memory utilization of each partitions a server hosts; and an affinity matrix. Further information can be determined from the partitions if required.

The server capacity estimator module (202) uses the monitoring information from the monitoring module and affinity module to determine a server capacity function (203).

The server capacity function (203) estimates the transaction rate a server can process given the current partition placement (205) and the determined affinity among partitions (206), preferably it is the maximum transaction rate. The maximum transaction rate value can be pre-determined. Preferably the server capacity function is estimated without prior knowledge of the database workload.

Information from the monitoring module and server capacity function or functions are input to the partition placement module (207), which computes a new mapping (208) of partitions to servers using the current mapping (205) of partitions on servers. If the new mapping is different from the current mapping, it is necessary to migrate partitions and possibly add or remove servers from the server pool.

Partition placement minimizes the number of servers used in the system and also the amount of data migrated for reconfiguration, since live data migration mechanisms cannot avoid aborting, blocking or delaying transactions the decision of transferring a partition preferably takes into consideration at least the current load, provided by the monitoring module, and the capacity of the servers involved in the migration, estimated by the server capacity estimator module.

Affinity Module

The affinity module determines the affinity class using an affinity matrix. The affinity class is used in one aspect by the server capacity estimator module and in another aspect by the partition placement module to determine a new partition mapping.

The affinity between two partitions p and q is the rate of transactions t accessing both p and q. In the preferred embodiment affinity is used to estimate the rate of distributed transactions resulting from a partition placement, that is, how many distributed transactions one obtains if p and q are placed on different servers.

In the preferred embodiment we use the following affinity class definitions for a workload in addition to the general definition earlier in the description:
null affinity—in workloads where all transactions access a single partition, the affinity among every pair of partitions is zero;
uniform affinity—in workloads if the affinity value is roughly the same across all partition pairs. Workloads are often uniform in large databases where partitioning is done automatically without considering application semantics: for example, if we assign a random unique id or hash value to each tuple and use it to determine the partition where the tuple should be placed. In many of these systems, transaction accesses to partitions are not likely to follow a particular pattern; and
arbitrary affinity—in workloads whose affinity is neither null nor uniform. Arbitrary affinity usually arises clusters of partitions are more likely to be accessed together.

The Affinity classes determine the complexity of server capacity estimation and partition planning. Simpler affinity patterns, for example null affinity, make capacity estimation simpler and partition placement faster.

The affinity class of a workload is determined by the affinity module using the affinity matrix, which counts how many transactions access each pair of partitions per unit time divided by the average number of partitions these transactions access (to avoid counting transactions twice). Over time, if the workload mix varies, the affinity matrix may change too.

In one aspect the monitoring module in the preferred embodiment monitors the servers and partitions and passes information to the Affinity module which detects when the affinity class of a workload changes and communicates this information about change in affinity to the server capacity estimator module and the partition placement module.

Server Capacity Estimator Module and the Server Capacity Function

The server capacity estimator module determines the throughput capacity of a server. The throughput capacity is the maximum number of transactions per second (tps) a server can sustain before its response time exceeds a user-defined bound.

In the presence of distributed transactions, server capacity cannot be easily characterized in terms of hardware utilization metrics, such as CPU utilization, because capacity can be bound by the overhead of blocking while coordinating distributed transactions. Distributed transactions represent a major bottleneck for a DBMS.

We use H-store an in-memory database system as an example in the preferred embodiment. Multi-partition transactions need to lock the partitions they access. Each multi-partition transaction is mapped to a base partition; the server hosting the base partition acts as a coordinator for the locking and commit protocols. If all partitions accessed by the transaction are local to the same server, the coordination requires only internal communication inside the server, which is efficient.

However, if some of the partitions are located on remote servers, ie. not all partitions are on the same physical server, blocking time while waiting for external partitions on other servers becomes significant.

The server capacity estimator module characterizes the capacity of a server as a function of the rate of distributed transactions the server executes.

The server capacity function depends on the rate of distributed transactions.

The rate of distributed transactions of a server s is a function of the affinity matrix F and of the placement mapping: for each pair of partitions p and q such that p is placed on s and q is not, s executes a rate of distributed transactions for p equal to F_{pq}. The server capacity estimator module outputs a server capacity function as:

c(s,A,F)

where partition placement is represented by the a binary matrix A, which is such that Aₚₛ=1 if and only if partition p is assigned to server s. This information is passed to the partition placement module, which uses it to make sure that new plans do not overload servers, and decide whether servers need to be added or removed.

The server capacity functions are based on the affinity class of the workload determined using the affinity module. The affinity class is used to calculate the distributed transaction rates. We determine the server capacity functions in the preferred embodiment for the null affinity class, the uniform affinity class and the arbitrary affinity class.

In one aspect of the preferred embodiment the dynamic nature of the workload and its several dimensions is considered. The dimensions of the workload include: horizontal skew, i.e. some partitions are accessed more frequently than others; temporal skew, i.e. the skew distribution changes over time; and load fluctuation, i.e. the overall transaction rate submitted to the system varies.

Other dimensions that influence the workload stability and homogeneity may also be considered.

Each server capacity function is specific to a global transaction mix expressed as a tuple [symbol] ƒ₁, . . . , ƒₙ [symbol] where ƒᵢ is fraction if transactions of type i in the current workload. Every time the transaction mix changes significantly, the current estimate of the capacity function c is discarded and a new estimate is rebuilt from scratch.

In one aspect of the preferred embodiment we may classify transactions on a single server, whether single-partition or multi-partition, as “local”. Multi-server are classified as distributed transactions.

In our experimental implementation the mix of transactions on partitions, local and distributed, does not generally vary. The transaction mix for partitions are reflected in the global transaction mix.

The server capacity function for null affinity workloads, where each transaction accesses a single partition, the affinity between every pair of partitions is zero and there are no distributed transactions.

Transactions accessing different partitions do not interfere with each other. Therefore, scaling out the system should results in a nearly linear capacity increase; the server capacity function is equal to a constant c̅ and is independent of the value of A and F:

c(s,A,F)=c̅

The server capacity is a function of the rate of distributed transactions: if the rate of distributed transactions is constant and equal to zero regardless of A, then the capacity is also constant.

We conducted experimental tests based on the preferred embodiment for different affinity classes.

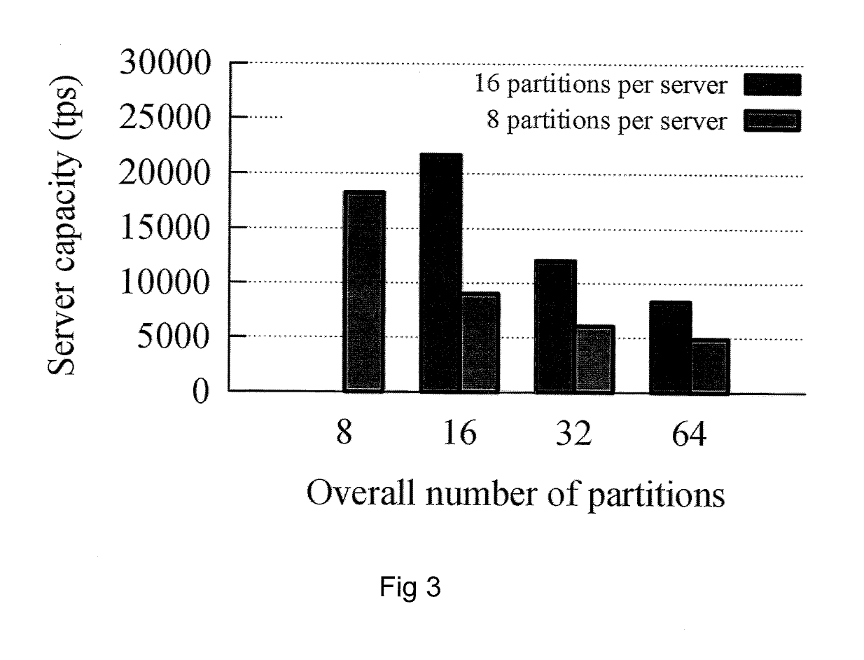

For null affinity workloads (FIG. 3) the different database sizes are reported on the x axis, and the two bars correspond to the two placements we consider. For a given total database size (x value), the capacity of a server is not impacted by the placement A. Consider for example a system with 32 partitions: if we go from a configuration with 8 partitions per servers (4 servers in total) to a configuration with 16 partitions (2 servers in total) the throughput per server does not change. This also implies that scaling out from 2 to 4 server doubles the overall system capacity: we have a linear capacity increment.

We validate this observation by evaluating YCSB as a representative of workloads with only single-partition transactions. We consider different databases with different size, ranging from 8 to 64 partitions overall, where the size of each partition is fixed. For every database size, we consider two placement matrices A: one where each server hosts 8 partition and one where each server hosts 16 partitions. The configuration with 8 partitions per server is recommended with H-Store since we use servers with 8 cores; with 16 partitions we have doubled this figure.

The server capacity function with uniform affinity where each pair of partitions is (approximately) equally likely to be accessed together, the rate of distributed transactions depends only on the number of partitions a server hosts: the higher the partition count per server, the lower the distributed transaction rate. The number of partitions per server determines the rate of multi-partition transactions that are not distributed but instead local to a server; these also negatively impact server capacity, although to a much less significant extent compared with the null affinity based server capacity function.

The server capacity function for workloads with uniform affinity is:

c(s,A,F)=ƒ(|{pεP:Aₚₛ=1}|)

where P is the set of partitions in the database.

For example using the preferred embodiment we apply the server capacity function considering a TPC-C workload. In TPC-C, 10% of the transactions access data belonging to multiple warehouses. In the implementation of TPC-C over H-Store, each partition consists of one tuple from the Warehouse table and all the rows of other tables referring to that warehouse through a foreign key attribute. Therefore, 10% of the transactions access multiple partitions. The TPC-C workload has uniform affinity because each multi-partition transaction randomly selects the partitions (i.e., the warehouses) it accesses following a uniform distribution.

Distributed transactions with uniform affinity have a major impact on server capacity (FIG. 3). We consider the same set of hardware configurations as for null affinity. Going from 8 to 16 partitions per server has a major impact in the capacity of a server in every configuration. some configurations in scaling out are actually detrimental; this can again be explained as an effect of server capacity being a function of the rate of distributed transactions.

Consider a database having a total of 32 partitions. The maximum throughput per server in a configuration with 16 partitions per server and 2 servers in total is approximately two times the value with 8 partitions per server and 4 servers in total. Therefore, scaling out does not increase the total throughput of the system in this example. This is because in TPC-C most multi-partition transactions access two partitions. With 2 servers about 50% of the multi-partition transactions are local to a server. After scaling out to 4 servers, this figure drops to 25% percent (i.e., we have 75% of distributed transactions). We see a similar effect when there is a total of 16 partitions. Scaling from 1 to 2 servers actually results in a reduction in performance, because multi-partition transactions that were all local are now 50% distributed.

Scaling out is more advantageous in configurations where every server hosts a smaller fraction of the total database. We see this effect starting with 64 partitions (FIG. 3). With 16 partitions per server (i.e., 4 servers) the capacity per server is less than 10000 so the total capacity is less than 40000. With 8 partitions per server (i.e., 8 servers) the total capacity is 40000. This gain increases as the size of the database grows. In a larger database with 256 partitions, for example, a server hosting 16 partitions hosts less than 7% of the database. Since the workload has uniform affinity, this implies that less than 7% of the multi-partition transactions access only partitions that are local to a server. If a scale out leaves the server with 8 partitions only, the fraction of partitions hosted by a server becomes 3.5%, so the rate of distributed transactions per server does not vary significantly in absolute terms. This implies that the additional servers actually contribute to increasing the overall capacity of the system.

The server capacity function with arbitrary affinity is where different servers have different rates of distributed transactions. The rate of distributed transactions for each server s can be expressed as a function dₛ(A,F) of the placement and the affinity matrix as we discussed earlier. If two transactions p and q are such that Aₚₛ=1 and A_{qs}=0, this adds a term equal to F_{pq} to the rate of distributed transactions executed by s. Since we have arbitrary affinity, the F_{pq} values will not be uniform. Capacity is also a function of the number of partitions a server hosts because this has impact on hardware utilization.

For arbitrary affinity server capacity is determined by the server capacity estimator module using several server capacity functions, one for each value of the number of partitions a server hosts. Each of these functions depends on the rate of distributed transactions a server executes.

The server capacity function for arbitrary affinity workloads is:

c(s,A,F)=ƒ_{q(s,A)}(dₛ(A,F))

where q(s, A)=|{pεP:Aₚₛ=1}| is the number of partitions hosted by server s and P is the set of partitions in the database.

A comparison with null affinity and uniform affinity is made using TPC-C. Since TPC-C has multi-partition transactions, we vary the rate of distributed transactions executed by a server, some of which are not distributed, and we change the rate of distributed transactions by modifying the fraction of multi-partition transactions in the benchmark.

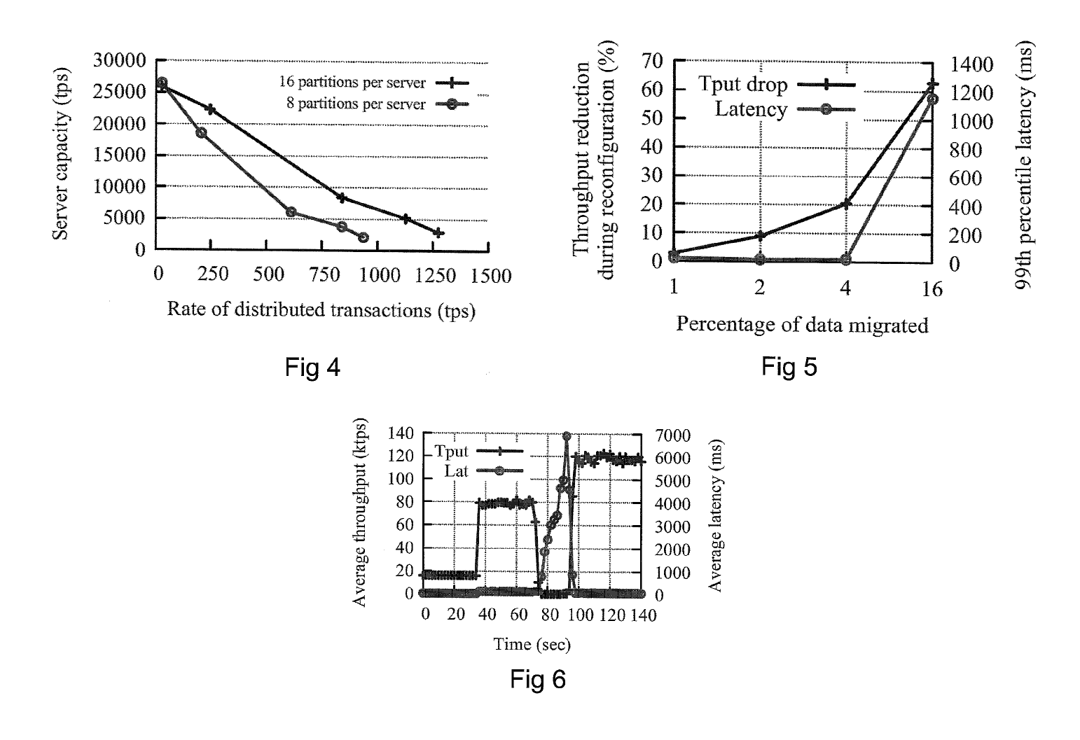

The variation in server capacity with a varying rate of distributed transactions in a setting with 4 servers, each hosting 8 or 16 TPC-C partitions, changes the shape of the capacity curve (FIG. 4) which depends on the number of partitions a server hosts.

A server with more partitions can execute transactions even if some of these partitions are blocked by distributed transactions. If a server with 8 cores runs 16 partitions, it is able to utilize its cores even if some of its partitions are blocked by distributed transactions. Therefore, the capacity drop is not as strong as with 8 partitions.

The relationship between the rate of distributed transactions and the capacity of a server is not necessarily linear. For example, with 8 partitions per server, approximating the curve with a linear function would overestimate capacity by almost 25% if there are 600 distributed transactions per second.

Determining the Server Capacity Function

The server capacity estimator module determines the server capacity function c online, by measuring at least the transaction rate and transaction latency for each server. Whenever latency exceeds a pre-defined bound for a server s, the current transaction rate of s is considered as an estimate of the server capacity for the “current configuration” of s.

In the preferred embodiment of the invention a bound is set on an average latency of 100 milliseconds. The monitoring module is preferrably continuously active and able to measure capacity (and activate reconfigurations) before latency and throughput degrade substantially.

A configuration is a set of input-tuples (s,A,F) that c maps to the same capacity value. The configuration is determined using the affinity class. For example, in one aspect of the preferred embodiment the null affinity will return one configuration for all values of (s,A,F). In contrast, for uniform affinity c returns a different value depending on the number of partitions of a server, so a configuration includes all input-tuples where s hosts the same number of partitions according to A. In arbitrary affinity, every input-tuple in (s,A,F) represents a different configuration.

The “current configuration” of the system depends on the type of server capacity function under consideration, for the preferred embodiment, this is null affinity, uniform affinity or arbitrary affinity.

Server capacity estimation with the workload having null affinity, the capacity is independent of the system configuration, so every estimate is used to adjust c̅ and is the simple average of all estimates, but more sophisticated estimations can be easily be integrated.

Server capacity estimation with the workload having uniform affinity, the capacity estimator returns a different capacity bound depending on the number of partitions a server hosts.

If the response latency exceeds the threshold for a server s, the current throughput of s is considered as an estimate of the server capacity for the number of partitions s currently hosts.

Server capacity estimation with the workload having arbitrary affinity, the throughput of s is considered a capacity estimate for the number of partitions s is hosting and for the distributed transaction rate it is executing. For arbitrary affinity we approximate capacity functions as a piecewise linear function.

If the estimator must return the capacity for a given configuration and no bound for this configuration has been observed so far, it returns an optimistic (i.e., high) bound that is provided, as a rough estimate, by the DBA.

The values of the capacity function are populated and the DBA estimate is refined with actual observed capacity. The DBA may specify a maximum number of partitions per server beyond which capacity drops to zero.

The server capacity function is specific to a given workload, which the server capacity estimator module characterizes in terms of transaction mix (i.e., the relative frequency of transactions of different types) and of affinity, as represented by the affinity matrix.

A Static workload will eventually stabilise the server capacity function.

A significant change in the workload mix detected by the server capacity estimator resets its capacity function estimation and re-evaluates the capacity function estimation anew. In in one aspect the server capacity function c is continuously monitored for changes. For example, in null and uniform affinity, the output of c for a given configuration may be the average of all estimates for that configuration. In arbitrary affinity, separate capacity functions are kept based on the number of partitions a server hosts.

The server capacity estimator module adapts to changes in the mix as long as the frequency of changes is low enough to allow sufficient capacity observations for each workload.

The output of the server capacity estimator module is used in the partition placement module.

Partition Placement Module

The partition placement module determines partition placement across the servers. The preferred embodiment uses a Mixed Integer Linear Programming (MILP) model to determine an optimised partition placement map.

The partition placement module operates multiple times during the lifetime of a database and can be invoked periodically or whenever the workload varies significantly or both. The partition placement module may invoke several instances of the MILP model in parallel for different numbers of servers. Parallel instances speeds up the partition placement.

The partition placement module in the preferred embodiment is invoked at a decision point t to redistribute the partitions. At each decision point one or more instances of the partition placement module is run, with each partition placement instance having a fixed number of servers N^{t}.

If no placement with N^{t} servers is found then preferably at least one of the following is done:

1) If the total load has increased since the last decision point, subsequent partition placement instances are run, each instance with one more server starting from the current number of servers, until a placement is found with the minimal value of N^{t}; and

2) If the total load has decreased, we run partition placement instances where N^{t} is equal to the current number of servers minus k, where k is a configurable parameter, for example k=2.

The number of servers are increased or decreased until a placement is found. The partition placement module may run the partition placement instances sequentially or in parallel.

Equation 4 shows a method to determine the partition placement instance at decision point t and a given number of server N^{t}. We use the superscript t to denote variables and measurements for decision point t.

At decision point t, a new placement A^{t} based on the previous placement A^{t-1} is determined. The partition placement module aims to minimize the amount of data moved for the reconfiguration; mₚ^{t} is the memory size of partition p and S is the maximum of N^{t-1} and value currently being considered for N^{t}. The first constraint expresses the throughput capacity of a server where rₚ^{t} is the rate of transactions accessing partition p, using the server capacity function c(s,A,F) for the respective affinity. The second constraint guarantees that the memory M of a server is not exceeded. This also places a limit on the number of partitions on a server, which counterbalances the desire to place many partitions on a server to minimize distributed transactions. The third constraint ensures that every partition is replicated k times. The preferred embodiment can be varied by configuring that every partition is replicated a certain number of times for durability. The last two constraints express that N^{t} servers must be used; the constraint is more strict than required to speed up solution time.

The input parameters r^{t} and m^{t} are provided by the monitoring module. The server capacity function c(s,A,F) is provided by the server capacity estimator module.

Partition placement module uses the constraints and problem formulation below to determine the new partition placement map.

$$minimize {\sum }_{p = 1}^{P} {\sum }_{s = 1}^{S} ( \vert {A}_{ps}^{t} - {A}_{ps}^{t - 1} \vert \cdot {m}_{p}^{t} ) \text{/} 2$$

$$s . t . ∀ s ∈ [ 1 , S ] \text{:} {\sum }_{p = 1}^{P} {A}_{ps}^{t} \cdot {r}_{p}^{t} < c ( s , A , F )$$

$$∀ s ∈ [ 1 , S ] \text{:} {\sum }_{p = 1}^{P} {A}_{ps}^{t} \cdot {m}_{p}^{t} < M$$

$$∀ p ∈ [ 1 , P ] \text{:} {\sum }_{s = 1}^{S} {A}_{ps}^{t} = k$$

$$∀ P ∈ [ 1 , {N}^{t} ] \text{:} {\sum }_{s = 1}^{S} {A}_{ps}^{t} > 0$$

$$∀ P ∈ [ {N}^{t} + 1 , S ] \text{:} {\sum }_{s = 1}^{S} {A}_{ps}^{t} = {0}^{*} - 0.7 {ex}^{*} - 0.7 ex$$

One source of non-linearity in this problem formulation is the absolute value |Aₚₛ^{t}−Aₚₛ^{t-1}| in the objective function.

We make the formulation linear by introducing A new decision variable y is introduced to make the formulation linear and replaces |Aₚₛ^{t}−Aₚₛ^{t-1}| in the problem, and we add two constraints of the form Aₚₛ^{t}−Aₚₛ^{t-1}−y≦0, −(Aₚₛ^{t}−Aₚₛ^{t-1})−y≦0.

In workloads with no distributed transactions and null affinity, the server capacity function c(s,A,F) is equal to a constant c̅.

In workloads with uniform affinity, the capacity of a server is a function of the number of partitions the server hosts, so we express c as a function of the new placement A^{t}. If we substitute c(s,A,F) in the first constraint of the problem formulation using the expression of A^{t} for uniform affinity and we obtain the following uniform affinity load constraint:

$$∀ s ∈ [ 1 , S ] \text{:} {\sum }_{p = 1}^{P} {A}_{ps}^{t} \cdot {r}_{p}^{t} \leq ( f \vert \{ p ∈ P \text{:} {A}_{ps}^{t} = 1 \} \vert )$$

where the function ƒ(q), which is provided as input by the server capacity estimator module, returns the maximum throughput of a server hosting q partitions.

The partition placement module uses uniform affinity load constraint in the problem formulation by using a set of binary indicator variables z_{qs}^{t}, indicating the number of partitions hosted by server: given a server s, z_{qs}^{t} is 1 with sε[1, S] and qε[1, P] such that z_{qs}^{t} is true if and only if server s hosts exactly q partitions in the new placement A^{t}. We add the following constraints to the partition mapper modules problem formulation:

$$∀ s ∈ [ 1 , S ] \text{:} {\sum }_{q = 1}^{P} {z}_{qs}^{t} = 1$$

$$∀ s ∈ [ 1 , S ] \text{:} {\sum }_{p = 1}^{P} {A}_{ps}^{t} = {\sum }_{q = 1}^{P} q \cdot {z}_{qs}^{t}$$

The first constraint mandates that, given a server s, exactly one of the variables z_{qs}^{t} has value 1. The second constraint has the number of partitions hosted by s on its left hand side. If this is equal to q^{t}, then z_{q}_{^{t}}ₛ^{t} must be equal to one to satisfy the constraint since the other indicator variables for s will be equal to 0.

We now reformulate the uniform affinity load constraint by using the indicator variables to select the correct capacity bound:

$$∀ s ∈ [ 1 , S ] \text{:} {\sum }_{p = 1}^{P} {A}_{ps}^{t} \cdot {r}_{p}^{t} \leq {\sum }_{q = 1}^{P} f ( q ) \cdot {z}_{qs}^{t}$$

ƒ(q) gives the capacity bound for a server with q partitions. If a server s hosts q′ partitions, z_{q}_{^{t}}ₛ^{t} will be the only indicator variable for s having value 1, so the sum at the right hand side will be equal to ƒ(q′).

For workloads where affinity is arbitrary, it is important to place partitions that are more frequently accessed together on the same server because this can substantially increase capacity as shown in the experimental results for the preferred embodiment. The problem formulation for arbitrary affinity uses the arbitrary affinity load constraint:

$$∀ s ∈ [ 1 , S ] \text{:} {\sum }_{p = 1}^{P} {A}_{ps}^{t} \cdot {r}_{p}^{t} \leq {f}_{q ( s , {A}^{t} )} ( {d}_{s}^{t} ( {A}^{t} , {F}^{t} ) )$$

where q(s,A^{t})=|{pεP:Aₚₛ^{t}=1}| is the number of partitions hosted by the server s.

The rate of distributed transactions for server s, dₛ^{t} is determined by the partition placement module and its value depends on the output variable A^{t}. The non-linear function dₛ is expressed in linear terms.

We want to count only distributed transactions, we need to consider only the entries of the affinity matrix related to partitions that are located in different servers. Consider a server s and two partitions p and q. if one of them is hosted by s, s has the overhead of executing the the distributed transactions accessing p and q. A binary three dimensional cross-server matrix C^{t} is determined such that C_{psq}^{t}=1 if and only if partitions p and q are mapped to different servers in the new placement A^{t} but at least one of them is mapped to server s:

C_{psq}^{t}=Aₚₛ^{t}⊕A_{qs}^{t}

were the exclusive or operator ⊕ is not linear. Instead of using the non-linear exclusive or operator, we define the value of C_{psq}^{t} in the context of the MILP formulation by adding the following linear constraints to Equation 4:

∀p,qε[1,P],sε[1,S]:C_{psq}^{t}≦Aₚₛ^{t}+A_{qs}^{t}

∀p,qε[1,P],sε[1,S]:C_{psq}^{t}≧Aₚₛ^{t}+A_{qs}^{t}

∀p,qε[1,P],sε[1,S]:C_{psq}^{t}≧A_{qs}^{t}−Aₚₛ^{t}

∀p,qε[1,P],sε[1,S]:C_{psq}^{t}≦2−Aₚₛ^{t}+A_{qs}^{t}

The affinity matrix and the cross-server matrix are sufficient to compute the rate of distributed transactions per server s as follows:

$${d}_{s}^{t} = {\sum }_{p , q = 1}^{P} {C}_{psq}^{t} \cdot {F}_{pq}^{t}$$

Expressing the load constraint in linear terms, the capacity bound in the presence of workloads with arbitrary affinity can be expressed as a set of functions where dₛ^{t} is the independent variable. Each function in the set is indexed by the number of partitions q that the server hosts, as from the arbitrary affinity load constraint.

The server capacity estimator module approximates each function ƒ_{q}(dₛ^{t}) as a continuous piecewise linear function. Consider a sequence of delimiters uᵢ that determine the boundaries of the pieces of the function, with iε[0,n]. Since the distributed transaction rate is non negative, we have u₀=0 and uₙ=C, where C is an approximate, loose upper bound on the maximum transaction rate a server can ever reach. Each capacity function ƒ_{q}(dₛ^{t}) is defined as follows:

ƒ_{q}(dₛ^{t})=a_{iq}·dₛ^{t}+b_{iq}ifuᵢ₋₁≦dₛ^{t}<uᵢ for some i>0

For each value of q, the server capacity component provides as input to the partition placement mapper an array of constants a_{iq} and b_{iq}, for iε[1, n], to describe the capacity function ƒ_{q}(dₛ^{t}). We assume that ƒ_{q}(dₛ^{t}) is non decreasing, so all a_{iq} are smaller or equal to 0. This is equivalent to assuming that the capacity of a server does not increase when its rate of distributed transaction increases. We expect this assumption to hold in every DBMS.

The capacity function provides an upper bound on the load of a server. If the piecewise linear function ƒ_{q}(dₛ^{t}) is concave (i.e., the area above the function is concave) or linear, we could simply bound the capacity of a server to the minimum of all linear functions constituting the pieces of ƒ_{q}(dₛ^{t}). This can be done by replacing the current load constraint with the following constraint as follows:

$$∀ s ∈ [ 1 , S ] , i ∈ [ 1 , n ] \text{:} {\sum }_{p = 1}^{P} {A}_{ps}^{t} \cdot {r}_{p}^{t} \leq {a}_{i} \cdot {d}_{s}^{t} + {b}_{i}$$

However, the function ƒ_{q}(dₛ^{t}) is not concave or linear in general. For example, the capacity function of FIG. 4 with 8 partitions is convex. If we would take the minimum of all linear functions constituting the piecewise capacity bound ƒ_{q}(dₛ^{t}), as done in the previous equation, we would significantly underestimate the capacity of a server: the capacity would already go to zero with dₛ^{t}=650 due to the steepness of the first piece of the function.

We can deal with convex functions by using binary indicator variables vₛᵢ such that vₛᵢ is equal to 1 if and only if dₛ^{t}ε[uᵢ₋₁,uᵢ]. Since we are using a MILP formulation, we need to define these variables through the constraints as follows:

$$∀ s ∈ [ 1 , S ] \text{:} {\sum }_{i = 1}^{n} {v}_{si} = 1$$

$$∀ s ∈ [ 1 , S ] , i ∈ [ 1 , n ] \text{:} {d}_{s}^{t} \geq {u}_{i - 1} - {u}_{i - 1} \cdot ( 1 - {v}_{si} )$$

$$∀ s ∈ [ 1 , S ] , i ∈ [ 1 , n ] \text{:} {d}_{s}^{t} \leq {u}_{i} + ( C - {u}_{i} ) \cdot ( 1 - {v}_{si} )$$

In these expressions, C can be arbitrarily large, but a tighter upper bound improves the efficiency of the solver because it reduces the solution space. We set C to be the highest server capacity observed in the system. The first constraint we added mandates that exactly one of the indicators vₛᵢ has to be 1. If v_{si′} is equal to 1 for some i=i′, the next two inequalities require that dₛ^{t}ε[u_{i′-1},uᵢ]. For every other i≠i′, the inequalities do not constrain dₛ^{t} because they just state that dₛ^{t}ε[0,C]. Therefore, we can use the new indicator variables to mark the segment that dₛ^{t} belongs to without constraining its value.

We can now use the indicator variables z_{qs} to select the correct function ƒ_{q} for server s, and the new indicator variables vₛᵢ to select the right piece i of the ƒ_{q} to be used in the constraint. A straightforward specification of the load constraint of Equation 7 would use the indicator variables as factors, as in the following form:

$$∀ s ∈ [ 1 , S ] \text{:} {\sum }_{p = 1}^{P} {A}_{ps}^{t} \cdot {r}_{p}^{t} \leq {\sum }_{q = 1}^{P} {z}_{qs} \cdot ( {\sum }_{i = 1}^{n} {v}_{si} \cdot ( {a}_{iq} \cdot {d}_{s}^{t} + {b}_{iq} ) )$$

However, z_{qs}, vₛᵢ and dₛ^{t} are all variables derived from A^{t}, so this expression is polynomial and thus non-linear.

Since the constraint is an upper bound, we can introduce a larger number of constraints that are linear and use the indicator variables to make them trivially met when they are not selected. The load constraint can thus be expressed as follows:

$$∀ s ∈ [ 1 , S ] , q ∈ [ 1 , P ] , i ∈ [ 1 , n ] \text{:} {\sum }_{p = 1}^{P} {A}_{ps}^{t} \cdot {r}_{p}^{t} \leq C \cdot ( 1 - {a}_{iq} ) \cdot ( 1 - {v}_{si} ) + C \cdot ( 1 - {a}_{iq} ) \cdot ( 1 - {z}_{qs} ) + {a}_{iq} \cdot {d}_{s}^{t} + {b}_{iq}$$

For example, a server s′ has q′ partitions, its capacity constraint if given by the capacity function ƒ_{q′}. If the rate of distributed transactions of s lies in segment i′ i.e. dₛ^{t}ε[u_{i′-1},u_{i′}] for the segment i′, we have that v_{s′i′}=1 and z_{q′s′}=1, so the constraint for s′, q′, i′, becomes:

$${\sum }_{p = 1}^{P} {A}_{{ps}^{′}}^{t} \cdot {r}_{p}^{t} \leq {a}_{{i}^{′} {q}^{′}} \cdot {d}_{{s}^{′}}^{t} + {b}_{{i}^{′} {q}^{′}}$$

which selects the function ƒ_{q′}(d_{s′}^{t}) and the right segment i′ to express the capacity bound of s′. For all other values of s, q and i, the inequality (for all values q≠q′ and i≠i′) does not constraint dₛ^{t} because either vₛᵢ=0 or z_{qs}=0, so the inequality becomes less stringent than dₛ^{t}≦C. This holds since all functions ƒ_{q}(dₛ^{t}) are non-increasing, so a_{iq}≦0.

In presence of arbitrary affinity, the partition placement module clusters affine partitions together and preferably attempts to places each cluster on a single server.

In the preferred embodiment clustering and placement are solved at once: since clusters of partitions are to be mapped onto a single server, the definition of the clusters need to take into consideration the load on each partition, the capacity constraints of the server that should host the partition, as well as the migration costs of transferring all partitions to the same server if needed.

The partition placement module and its use of the problem formulation implicitly clusters affine partitions and places them to the same server. Feasible solutions are explored for a given number of servers and searches for the solution which minimizes data migration. Data migration is minimized by maximizing the capacity of a server, which is done by placing affine partitions onto the same server.

### Experimental Study

The preferred embodiment has been studied by conducting experiments on two workloads, TPC-C and YCSB. The preferred embodiment workloads are run on H-Store. H-store is an experimental main-memory, parallel database management system for on-line transaction processing (OLTP) applications. A typical set-up comprises a cluster of shared-nothing, main memory executor nodes. Although, embodiments of the invention are not limited to the preferred embodiment, some changes are made to the preferred embodiment used to demonstrate the present invention. It is feasible for a person skilled in the art to implement embodiments of the present invention on a disk based system, or a mixture of disk and in-memory systems. Embodiments of the present invention, once implemented, and partitions set-up may run reliably without human supervision.

The preferred embodiment of the present invention supports replication of partitions, the experimental embodiment using H-Store is not implemented using replication, as it demonstrates a simple to understand embodiment of the present invention. Other aspects of the invention are considered above.

Thus, we set k=1 (no replication), although embodiments of the present invention are not limited to k=1. The initial mapping configuration A⁰ is computed by starting from an infeasible solution where all partitions are hosted by one server.

The databases sizes we consider range from 64 partitions to 1024 partitions. Every partition is 1 GB in size, then 1024 partitions represents a database size of 1 TB.

We demonstrate the preferred embodiment of the present invention using the experimental embodiment by conducting a stress-test using the partition placement module, we set the partition sizes so that the system is never memory bound in any configuration. That way partitions can be migrated freely between servers, and we can evaluate the effectiveness of the partition placement module of the present embodiment at finding good solutions (few partitions migrated and few servers used).

For our experiments, we used a fluctuating workload to drive the need for reconfiguration. The fluctuation in overall intensity (in transactions per second) of the workload that we use follows the access trace of Wikipedia for a randomly chosen day, Oct. 8, 2013. In that day, the maximum load is 50% higher than the minimum. We repeat the trace, so that we have a total workload covering two days. The initial workload intensity was chosen to require frequent reconfigurations. We run reconfiguration periodically, every 5 minutes, and we report the results for the second day of the workload (representing the steady state). We skew the workload such that 20% of the transactions access “hot” partitions and the rest access “cold” partitions. The number of hot partitions is the minimum needed to support 20% of the workload without exceeding the capacity bound of a single partition. The set of hot and cold partitions is changed at random in every reconfiguration interval.

The embodiments of the present invention minimize the amount of data migrated between servers. We compare the preferred embodiment of the present invention with standard methods. We also evaluate the impact of data migration on system performance.

Our control experiment uses a YCSB instance with two servers, where each server stores 8 GB of data in main memory. We saturate the system and transfer a growing fraction of the database from the second server to a new, third server using one of H-Store's data migration mechanisms. In this experiment we migrate the least accessed partitions. Every reconfiguration completed in less than 2 seconds, and FIG. 5 illustrates the throughput drop and 99th percentile transaction latency during these 2 seconds. Throughput is impacted even if we are migrating the least accessed partitions. If less than 2% of the database is migrated, the throughput reduction is almost negligible, but it starts to be noticeable when 4% of the database or more is migrated. A temporary throughput reduction during reconfiguration is unavoidable, but since the duration of reconfigurations is short, the system can catch up quickly after the reconfiguration. There is no perceptible effect on latency except when 16% of the database is migrated, at which time we see a spike in 99th percentile latency. This experiments validates the need for minimizing the amount of data migration, and quantifies the effect of data migration. The present invention and its embodiments in one aspect minimise the amount of data migrated.

We now demonstrate (FIG. 6) in experiment 1 a reconfiguration performed using the present invention with the same YCSB database as in the control experiment above. Initially, the system uses two servers that are not highly loaded. We record the changes in the system at a time measured in seconds from the start of the experiment. At 35 seconds from the start of the experiment, we increase the offered load, resulting in an overload of the two servers. At 70 seconds from the start of the experiment, we invoke the experimental embodiment of the present invention. The experimental embodiment decides to add a third server and to migrate 7.5% of the partitions, the most frequently accessed ones. Due to the high load on the system, for a short interval, the throughput drops and the average latency spikes. However, after this short reconfiguration the system is able to resume operation at low latency and a much higher throughput compared to the throughput before reconfiguration. The drop in throughput is more severe than the control experiment because reconfiguration moves the most frequently accessed partitions.

We compare one aspect of the embodiments of the present invention with known methods, Equal and Greedy using workload YCSB, where all transactions access only a single partition. Embodiments of the present invention are not limited to use with single partition access. Depending on the number of partitions, initial loads range from 40,000 to 240,000 transactions per second.

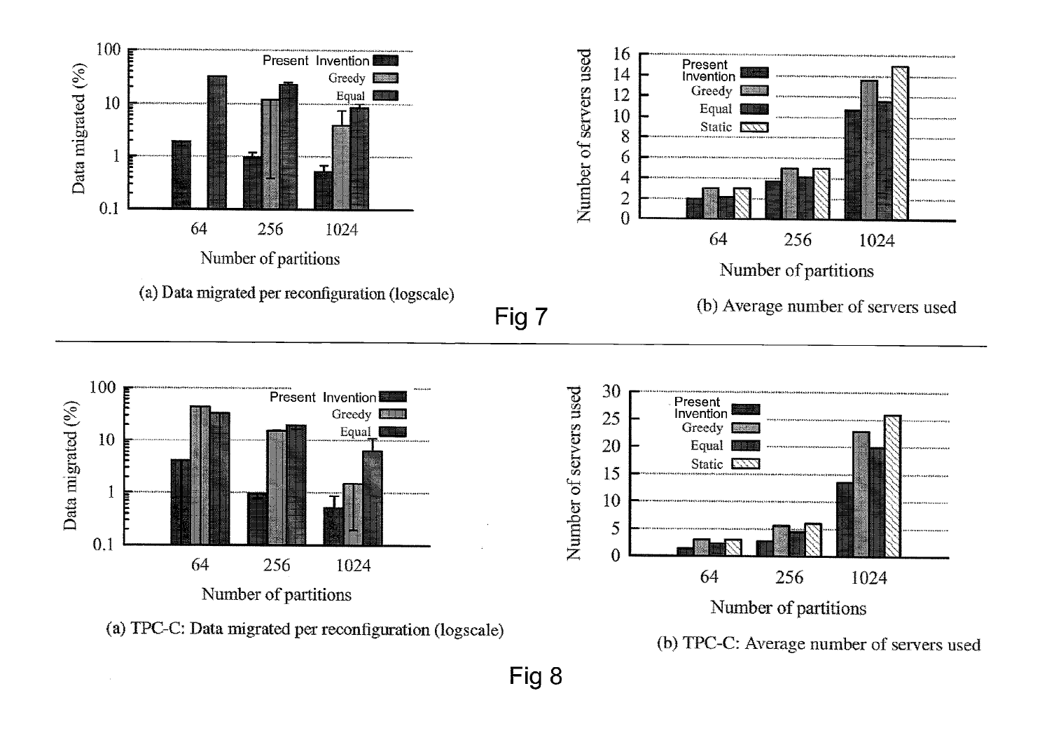

To demonstrate the advantages of the present invention we compare the present invention with conventional methods (FIG. 7) using the average number of partitions moved in all the reconfiguration steps executed on the second day. We use a logarithmic scale for the y axis due to the high variance (FIG. 7) also includes error bars reporting the 95th percentile. The important metrics for a comparison are the amount of data moved (partitions-FIG. 7) by the present invention and other methods to adapt and the number of servers they require (FIG. 7).

It is common practice in distributed data stores and DBMSes to use a static hash- or range-based placement in which the number of servers is provisioned for peak load, assigning equal amount of data to each server. The maximum number of servers used by Equal over all reconfigurations represents a viable static configurations that is provisioned for peak load, it is the Static policy. This policy represents a best-case static configuration in the sense that it assumes the knowledge of online workload dynamics that might not be known a priori, when a static configuration is typically devised.

The preferred embodiment of the present invention migrates a very small fraction of partitions. This fraction is always less than 2% on average, and the 95th percentiles are close to the average. Even though Equal and Greedy are optimized for single-partition transactions, the advantage of the present invention shows in the results. The Equal placement method uses a similar number of servers on average as the preferred embodiment of the present invention, but Equal migrates between 16× and 24× more data than the preferred embodiment of the present invention on average, with very high 95th percentile. Greedy migrates slightly less data than Equals, but uses a factor between 1.3× and 1.5× more servers than the preferred embodiment of the present invention, and barely outperforms the Static policy.

These results (FIG. 7) show the advantage of using the present invention over heuristics based Equal and Greedy, especially since the preferred embodiment of the present invention can use the partition placement module to determine solutions in a very short time. No heuristic based method can achieve the same quality in trading off the two conflicting goals of minimizing the number of servers and the amount of data migration. The Greedy heuristic is good at reducing migration, but cannot effectively aggregate the workload onto fewer servers. The Equal heuristic aggregates more aggressively at the cost of more migrations.

In experiment 2 we consider a workload such as TPC-C, having distributed transactions and uniform affinity. The initial transaction rates are 9,000, 14,000 and 46,000 tps for configurations with 64, 256 and 1024 partitions, respectively.

We compare the average fraction of partitions moved in all reconfiguration steps in the TPC-C scenario and also the 95th percentile for the preferred embodiment of the present invention, Equal and Greedy methods. The preferred embodiment of the present invention achieves even more server cost reduction than with YCSB compared to the Equal and Greedy methods. The preferred embodiment of the present invention migrates less than 4% in the average case, while Equal and Greedy methods migrate significantly more data. The other policies (Equal and Greedy) have all configurations where they migrate the partitions, and sometimes significantly more.

We show the advantage of using the preferred embodiment of the present invention over heuristics based Equal and Greedy (FIG. 8) with distributed transactions, the preferred embodiment of the present invention outperforms the other methods in terms of number of servers used (FIG. 8). Greedy uses between 1.7× to 2.2× more servers on average, Equal between 1.5× and 1.8×, and Static between 1.9× and 2.2×.

In experiment 3 we consider workloads with arbitrary affinity. We modify TPC-C to bias the affinity among partitions: each partition belongs to a cluster of 4 partitions in total. Partitions inside the same cluster are 10 times more likely to be accessed together by a transaction than to be accessed with partitions outside the cluster. For Equal and Greedy, we select an average capacity bound that corresponds from a random distribution of 8 partitions to servers.

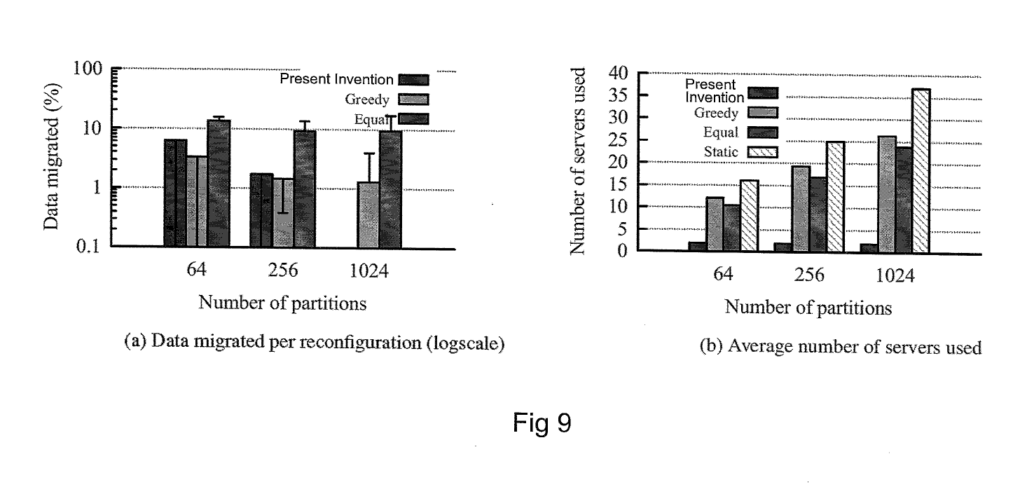

The advantage of the preferred embodiment of the present invention becomes apparent when for the results with 64 partitions and an initial transaction rate of 40000 tps (FIG. 9). The results show the highest gains using the preferred embodiment of the present invention across all the workloads we considered. The preferred embodiment of the present invention manages to reduce the average number of servers used by a factor of more then 5× compared with 64 partitions, and of more than 10× with 1024 partitions, with a 17× gain compared to Static.

The significant cost reduction achieved by the preferred embodiment of the present invention is due to its implicit clustering: by placing together partitions with high affinity, the preferred embodiment of the present invention boosts the capacity of the servers, and therefore needs less servers to support the workload.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

### TECHNIQUES FOR IMPLEMENTING ASPECTS OF EMBODIMENTS OF THE INVENTION

[1] P. M. G. Apers. Data allocation in distributed database systems. Transactions On Database Systems (TODS), 13(3), 1988.
[2] M. Armbrust, A. Fox, R. Griffith, A. D. Joseph, R. Katz, A. Konwinski, G. Lee, D. Patterson, A. Rabkin, I. Stoica, and M. Zaharia. A view of cloud computing. Communications of ACM (CACM), 53(4), 2010.
[3] J. Baker, C. Bond, J. Corbett, J. Furman, A. Khorlin, J. Larson, J.-M. Léon, Y. Li, A. Lloyd, and V. Yushprakh. Megastore: Providing scalable, highly available storage for interactive services. In CIDR, volume 11, pages 223-234, 2011.
[4] S. Barker, Y. Chi, H. J. Moon, H. Hacigümüs, and P. Shenoy. Cut me some slack: latency-aware live migration for databases. In Proceedings of the 15th International Conference on Extending Database Technology, pages 432-443. ACM, 2012.
[5] B. F. Cooper, A. Silberstein, E. Tam, R. Ramakrishnan, and R. Sears. Benchmarking cloud serving systems with YCSB. In Proc. Symposium on Cloud Computing (SOCC), 2010.
[6] G. P. Copeland, W. Alexander, E. E. Boughter, and T. W. Keller. Data placement in Bubba. In Proc. Int. Conf. on Management of Data (SIGMOD), 1988.
[7] J. C. Corbett, J. Dean, M. Epstein, A. Fikes, C. Frost, J. Furman, S. Ghemawat, A. Gubarev, C. Heiser, P. Hochschild, et al. Spanner: Googleâ [symbol] ™s globally-distributed database. In Proceedings of OSDI, volume 1, 2012.
[8] C. Curino, E. P. Jones, S. Madden, and H. Balakrishnan. Workload-aware database monitoring and consolidation. In Proc. Int. Conf. on Management of Data (SIGMOD), 2011.
[9] C. Curino, E. Jones, Y. Zhang, and S. Madden. Schism: a workload-driven approach to database replication and partitioning. Proceedings of the VLDB Endowment (PVLDB), 3(1-2), 2010.
[10] S. Das, D. Agrawal, and A. El Abbadi. Elastras: an elastic transactional data store in the cloud. In Proc. HotCloud, 2009.
[11] S. Das, S. Nishimura, D. Agrawal, and A. El Abbadi. Albatross: lightweight elasticity in shared storage databases for the cloud using live data migration. Proceedings of the VLDB Endowment, 4(8):494-505, 2011.
[12] A. J. Elmore, S. Das, D. Agrawal, and A. El Abbadi. Zephyr: live migration in shared nothing databases for elastic cloud platforms. In Proceedings of the 2011 ACM SIGMOD International Conference on Management of data, pages 301-312. ACM, 2011.
[13] D. V. Foster, L. W. Dowdy, and J. E. A. IV. File assignment in a computer network. Computer Networks, 5, 1981.
[14] K. A. Hua and C. Lee. An adaptive data placement scheme for parallel database computer systems. In Proc. Int. Conf. on Very Large Data Bases (VLDB), 1990.
[15] R. Kallman, H. Kimura, J. Natkins, A. Pavlo, A. Rasin, S. Zdonik, E. P. C. Jones, S. Madden, M. Stonebraker, Y. Zhang, J. Hugg, and D. J. Abadi. H-store: a high-performance, distributed main memory transaction processing system. Proceedings of the VLDB Endowment (PVLDB), 1(2), 2008.
[16] M. Mehta and D. J. DeWitt. Data placement in shared-nothing parallel database systems. Very Large Data Bases Journal (VLDBJ), 6(1), 1997.
[17] U. F. Minhas, R. Liu, A. Aboulnaga, K. Salem, J. Ng, and S. Robertson. Elastic scale-out for partition-based database systems. In Proc. Int. Workshop on Self-managing Database Systems (SMDB), 2012.
[18] A. Pavlo, C. Curino, and S. B. Zdonik. Skew-aware automatic database partitioning in shared-nothing, parallel oltp systems. In Proc. Int. Conf. on Management of Data (SIGMOD), 2012.
[19] D. Saccà and G. Wiederhold. Database partitioning in a cluster of processors. In Proc. Int. Conf. on Very Large Data Bases (VLDB), 1983.
[20] J. Schaffner, T. Januschowski, M. Kercher, T. Kraska, H. Plattner, M. J. Franklin, and D. Jacobs. Rtp: Robust tenant placement for elastic in-memory database clusters. 2013.
[21] Database Sharding at Netlog, with MySQL and PHP. http://nl.netlog.com/go/developer/blog/blogid=3071854.
[22] The TPC-C Benchmark, 1992. http://www.tpc.org/tpcc/.
[23] B. Trushkowsky, P. Bodk, A. Fox, M. J. Franklin, M. I. Jordan, and D. A. Patterson. The scads director: scaling a distributed storage system under stringent performance requirements. In Proceedings of the 9th USENIX conference on File and storage technologies, pages 12-12. USENIX Association, 2011.
[24] J. Wolf. The placement optimization program: a practical solution to the disk file assignment problem. In Proc. Int. Conf. on Measurement and Modeling of Computer Systems (SIGMETRICS), 1989.

1. A method of redistributing partitions between servers, wherein the servers host the partitions and one or more of the partitions are operable to process transactions, each transaction operable to access one or a set of the partitions, the method comprising:
determining an affinity measure between the partitions, the affinity being a measure of how often transactions have accessed the one or the set of respective partitions;
determining a partition mapping in response to a change in a transaction workload on at least one partition, the partition mapping being determined using the affinity measure; and
redistributing at least the one partition between servers according to the determined partition mapping.

2. The method of claim 1 further comprising:
determining a transaction rate for the number of transactions processed by the one or more partitions across the respective servers; and
determining the partition mapping using the transaction rate.

3. The method of claim 1 further comprising:
dynamically determining a server capacity function; and determining the partition mapping using the determined server capacity function.

4. The method of claim 3 wherein: the transaction workload on each server is below a determined server capacity function value, and wherein the transaction workload is an aggregate of transaction rates.

5. The method of claim 1 wherein the partition mapping further comprises determining a predetermined number of servers needed to accommodate the transactions; and redistributing the at least one partition between the predetermined number of servers, wherein the predetermined number of servers is different to the number of the servers hosting the partitions.

6. The method of claim 5 wherein the predetermined number of servers is a minimum number of servers.

7. The method of claim 1, wherein the server capacity function is determined using the affinity measure.

8. The method of claim 1, wherein the affinity measure is at least one of: a null affinity class; a uniform affinity class; and an arbitrary affinity class.

9. The method of claim 1, further comprising wherein the partition is replicated across at least one or more servers.

10. A system of redistributing partitions between servers, wherein the servers host the partitions and one or more of the partitions are operable to process transactions, each transaction being operable to access one or a set of partitions, the system comprising:
an affinity module operable to determine an affinity between the one or the set of respective partitions, wherein the affinity measure is a measure of how often transactions access the one or the set of respective partitions;
a partition placement module operable to receive the affinity measure, and to determine a partition mapping in response to a change in a transaction workload on at least the one partition; and
a redistribution module operable to redistribute at least the one partition between the servers according to the determined partition mapping.

11. The system of claim 10 further comprising: a server capacity estimator module operable to determine a maximum transaction rate for the servers; and
a monitoring module operable to determine a transaction rate of the number of transactions processed by the partitions on the each respective server.

12. The system of claim 11 wherein: the server capacity estimator module is operable to dynamically determine a server capacity function.

13. The system of claim 10 wherein: the transaction workload on the each server is below a determined server capacity function value, and wherein the transaction workload is the aggregate transaction rate.

14. The system of claim 12 wherein: the server capacity function is determined using the affinity measure.

15. The system of claim 10 wherein the partition mapping further comprises determining the predetermined number of servers needed to accommodate the transactions; and redistributing the at least one partition between the predetermined number of servers, wherein the predetermined number of servers is different to the number of the servers hosting the partitions.

16. The system of claim 15 wherein the predetermined number of servers is a minimum number of servers.

17. The system of claim 10, wherein the affinity measure is defined as at least one of: a null affinity class; a uniform affinity class; and an arbitrary affinity class.

18. The system of claim 10, wherein the partition is replicated across at least one or more of the servers.

19. A computer program embedded on a non-transitory tangible computer readable storage medium, the computer program including machine readable instructions that, when executed by a processor, implement a method of redistributing partitions between servers, wherein the servers host the partitions and one or more of the partitions are operable to process transactions, each transaction operable to access one or a set of the partitions, the method comprising:
determining an affinity measure between the partitions, the affinity being a measure of how often transactions have accessed the one or the set of respective partitions;
determining a partition mapping in response to a change in a transaction workload on at least one partition, the partition mapping being determined using the affinity measure; and
redistributing at least the one partition between servers according to the determined partition mapping.
